(19) United States
(12) Patent Application Publication
(10) Pub. No.: US 2018/0118224 A1
(43) Pub. Date: May 3, 2018

(54) DISPLAY CONTROL DEVICE, DISPLAY DEVICE, AND DISPLAY CONTROL METHOD

(71) Applicant: MITSUBISHI ELECTRIC CORPORATION, Tokyo (JP)

(72) Inventors: Hidekazu ARITA, Tokyo (JP); Mitsuo SHIMOTANI, Tokyo (JP)

(73) Assignee: MITSUBISHI ELECTRIC CORPORATION, Tokyo (JP)

(21) Appl. No.: 15/572,712

(22) PCT Filed: Jul. 21, 2015
(86) PCT No.: PCT/JP2015/070702

§ 371 Date: Nov. 8, 2017

(51) Int. Cl. B60W 50/14; B60K 35/00; B60Q 1/24; G09G 5/38; G08G 1/16

(52) U.S. Cl. CPC B60W 50/14; B60K 35/00; B60Q 1/24; G09G 5/38; G09G 2340/0464; B60K 2350/965; B60K 2350/2052; B60W 2050/146; G09G 2380/10; G08G 1/16

(57) ABSTRACT

A virtual image display can display a display object being a virtual image in a virtual image position determined by a virtual image direction which is a direction of the virtual image and a virtual image distance which is a distance to the virtual image. A display control device includes a relative position acquisition part for obtaining a relative position of an attention object and the vehicle and a controller for controlling a display of the virtual image display. When the controller displays the visual guidance object which is a display object to guide a visual line of a driver to the attention object, the controller changes the virtual image direction and the virtual image distance of the visual guidance object in accordance with time so that the visual guidance object seems to move toward the position of the attention object as viewed from the driver.

### TECHNICAL FIELD

The present invention relates to a display control device for controlling a virtual image display and a display control method using the virtual image display.

### BACKGROUND ART

Various techniques are proposed with regard to a head-up display (HUD) for displaying an image on a windshield of a vehicle. For example, proposed is a HUD for displaying an image as a virtual image as if it really existed in a real landscape in front of the vehicle as viewed from a driver. For example, Patent Document 1 proposes a HUD which changes a distance between an apparent position of a virtual image and a driver in accordance with a vehicle speed.

### PRIOR ART DOCUMENTS

### Patent Documents

Patent Document 1: Japanese Patent Application Laid-Open No. 6-115381

### SUMMARY

### Problem to be Solved by the Invention

However, the above conventional technique of displaying the image as the virtual image cannot sufficiently rouse attention of a driver to an attention object (an object to which a driver should be alerted) such as a human or a bicycle.

The present invention has been achieved to solve problems as described above, and it is an object of the present invention to provide a technique capable of sufficiently rousing attention of a driver to an attention object.

### Means to Solve the Problem

A display control device according to the present invention is a display control device for controlling a virtual image display, wherein the virtual image display can display a display object being a virtual image which can be visually recognized from a driver's seat of a vehicle through a windshield of the vehicle in a virtual image position defined by a virtual image direction which is a direction of the virtual image on a basis of a specific position of the vehicle and a virtual image distance which is a distance to the virtual image on a basis of said specific position, and the display control device comprises; a relative position acquisition part to obtain a relative position of an attention object to which a driver of the vehicle should be alerted and the vehicle; and a controller to control a display of the virtual image display, and when the controller displays a visual guidance object which is a display object to guide a visual line of the driver to the attention object, the controller changes a virtual image position of the visual guidance object, based on the relative position of the vehicle and the attention object, so that the visual guidance object seems to move toward a position of the attention object as viewed from the driver.

### Effects of the Invention

According to the present invention, the movement of the visual guidance object effectively guides the visual line of the driver toward the attention object, thus the attention of the driver to the attention object can be sufficiently roused.

These and other objects, features, aspects and advantages of the present invention will become more apparent from the following detailed description of the present invention when taken in conjunction with the accompanying drawings.

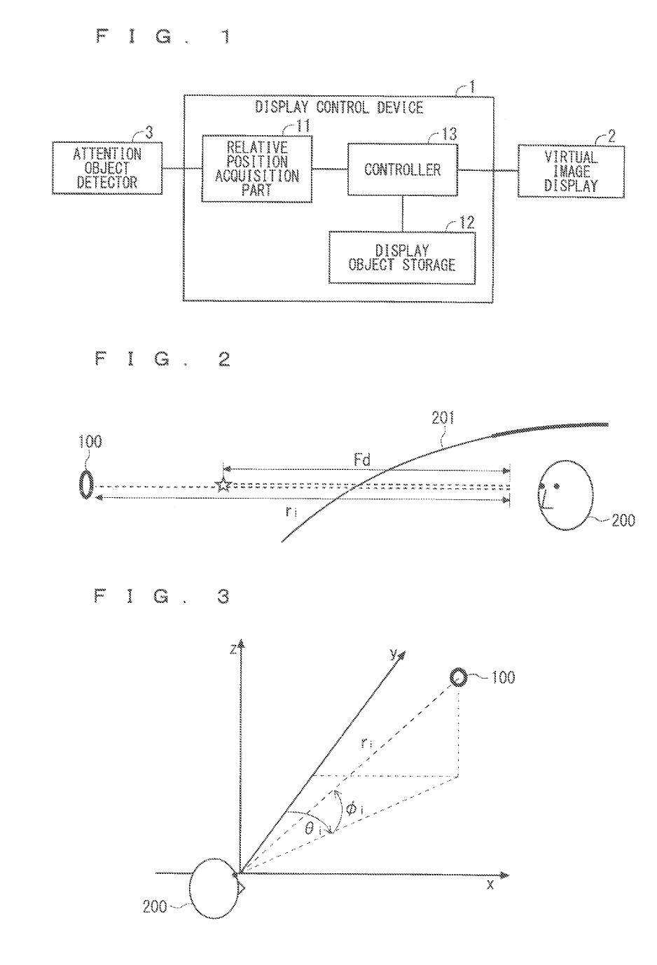

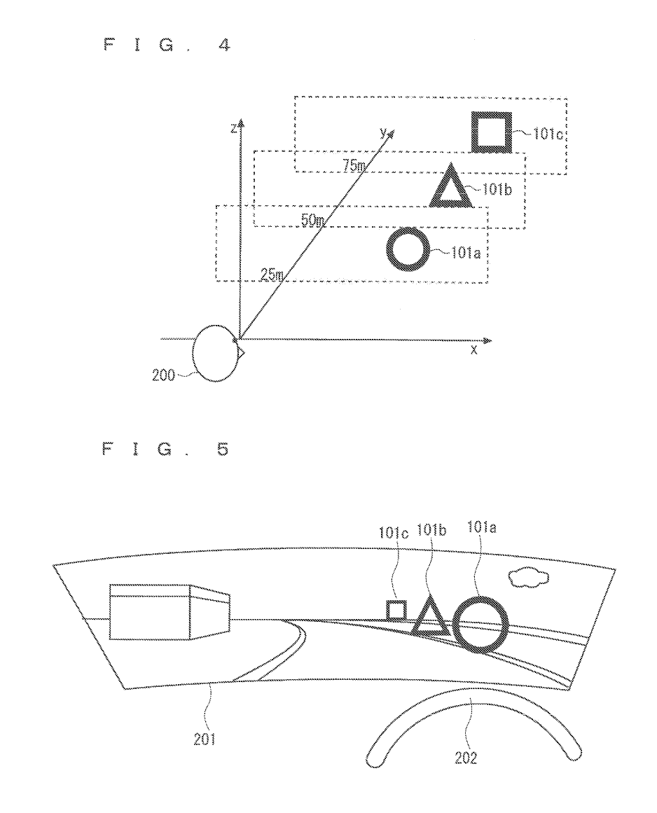

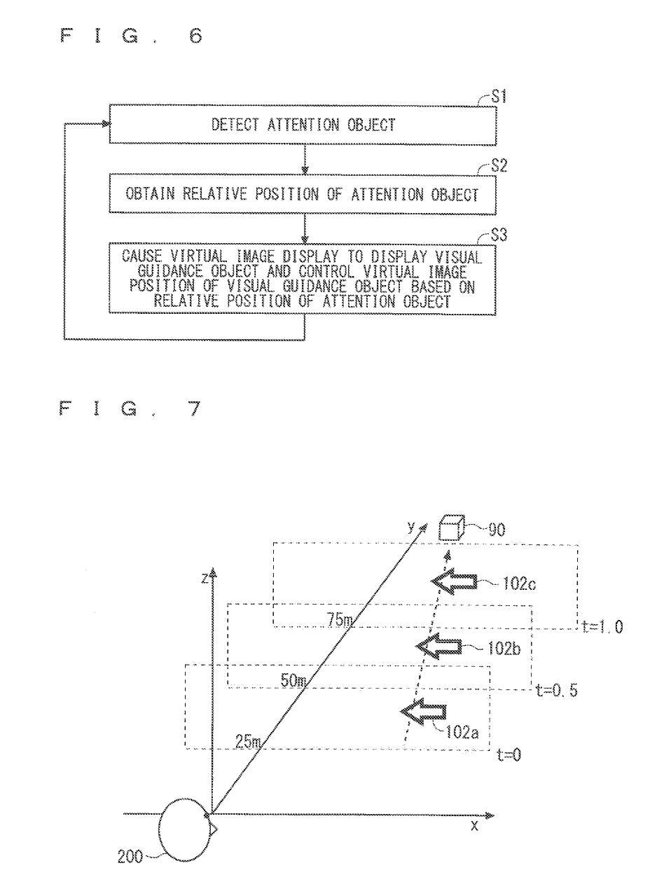

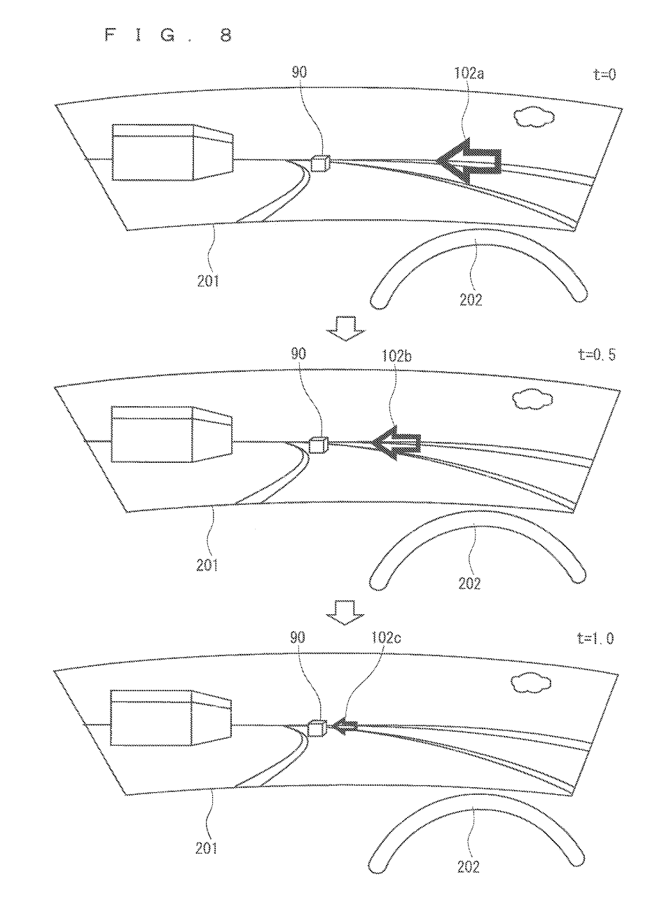

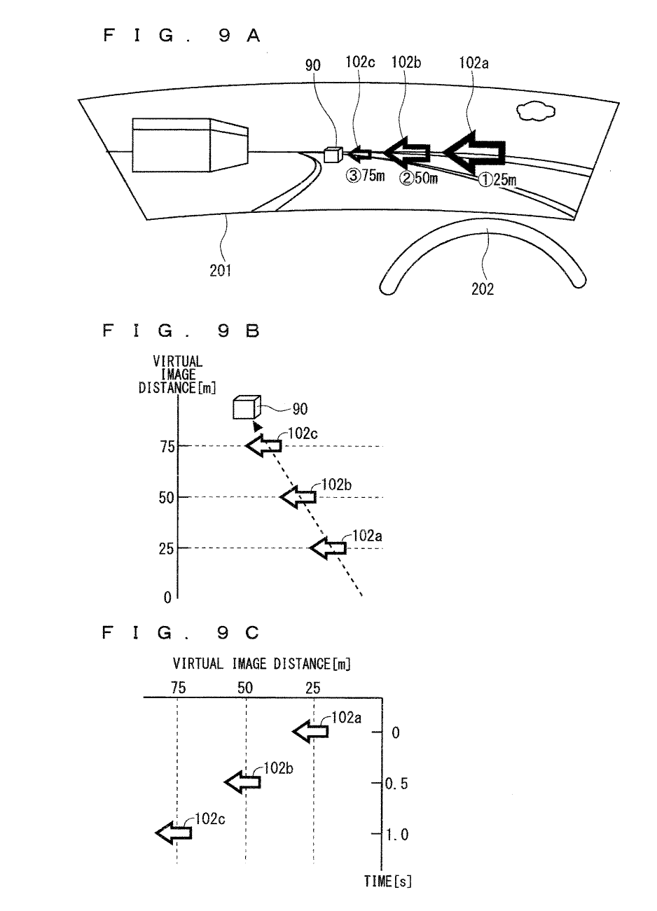

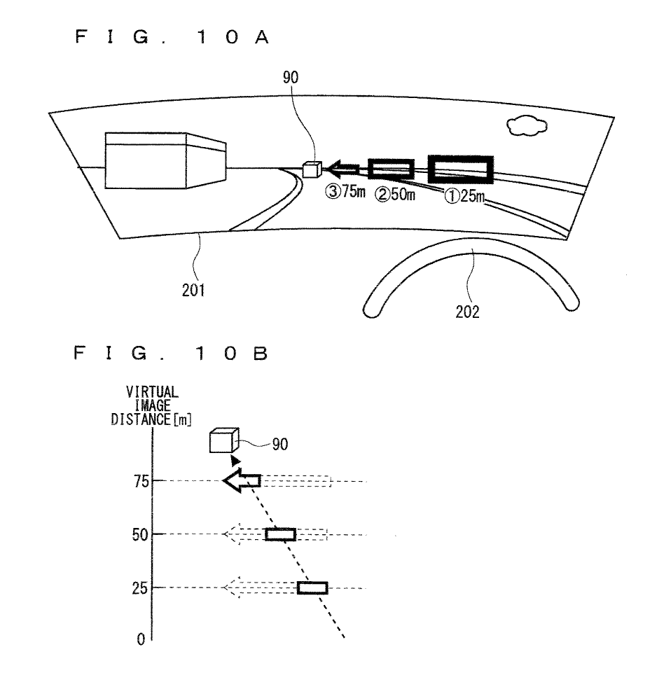

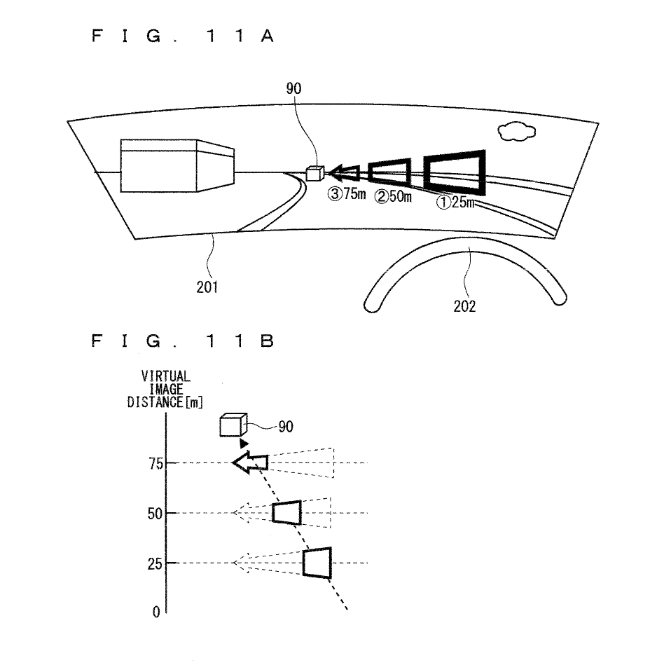

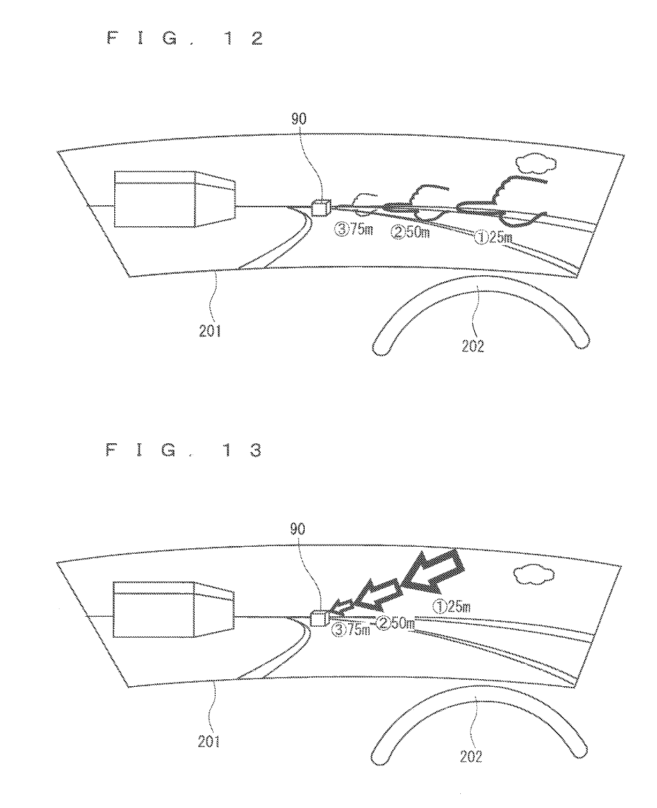

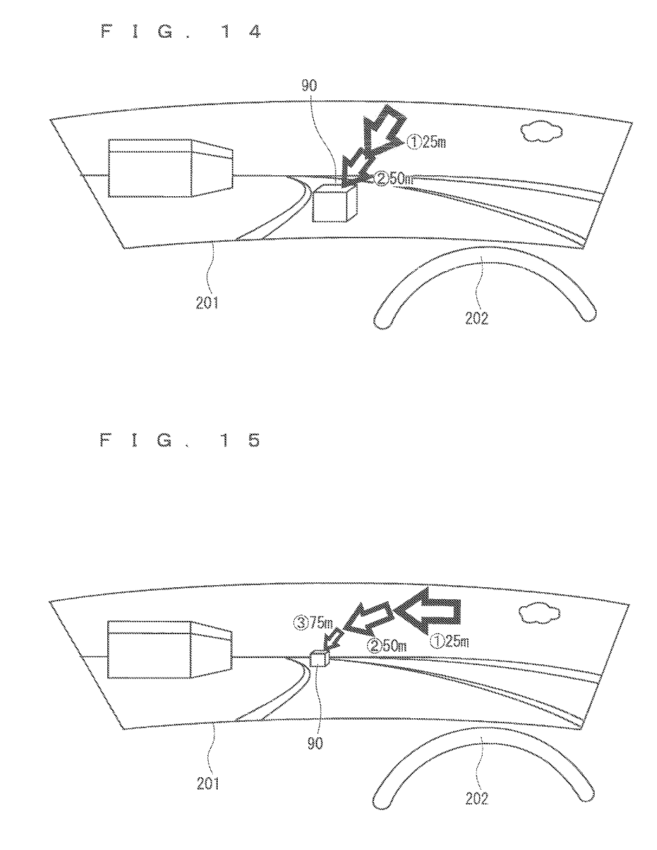

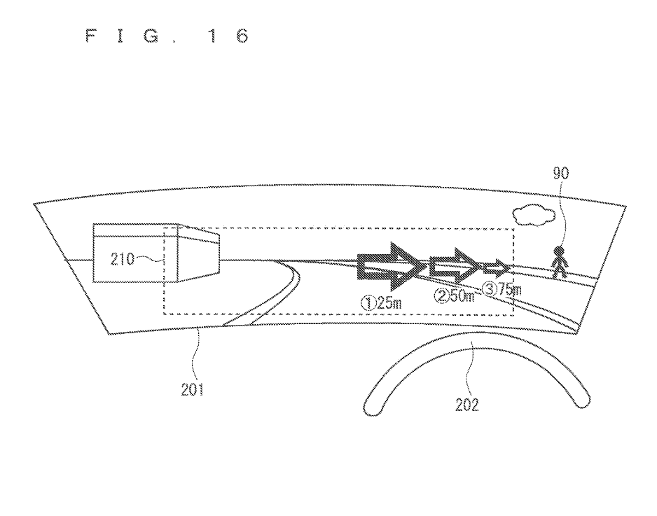

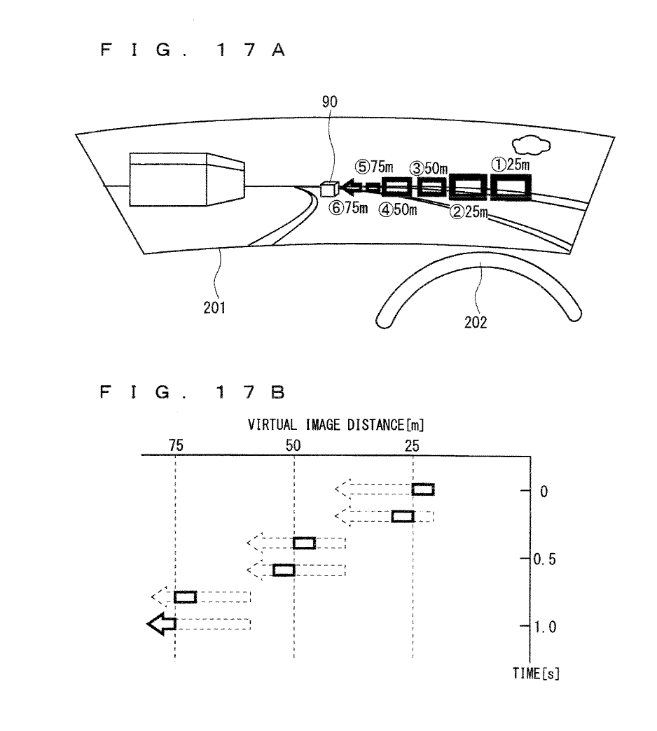

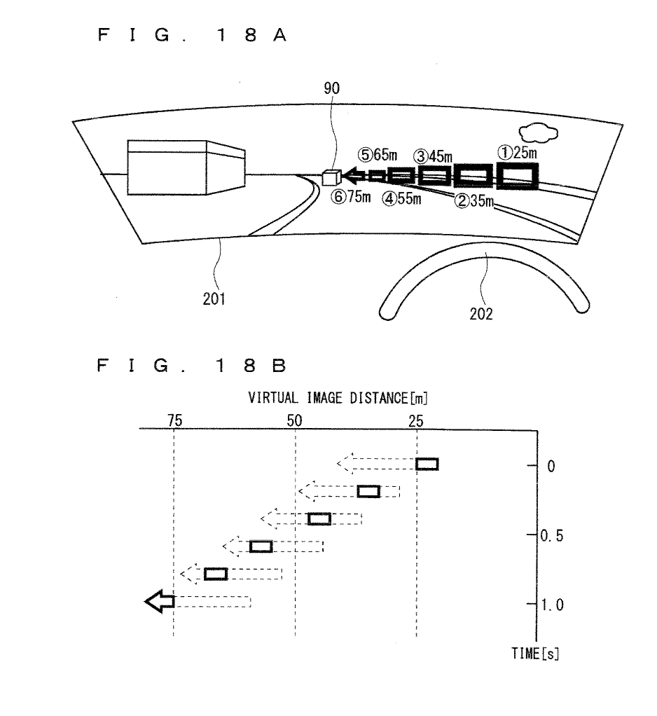

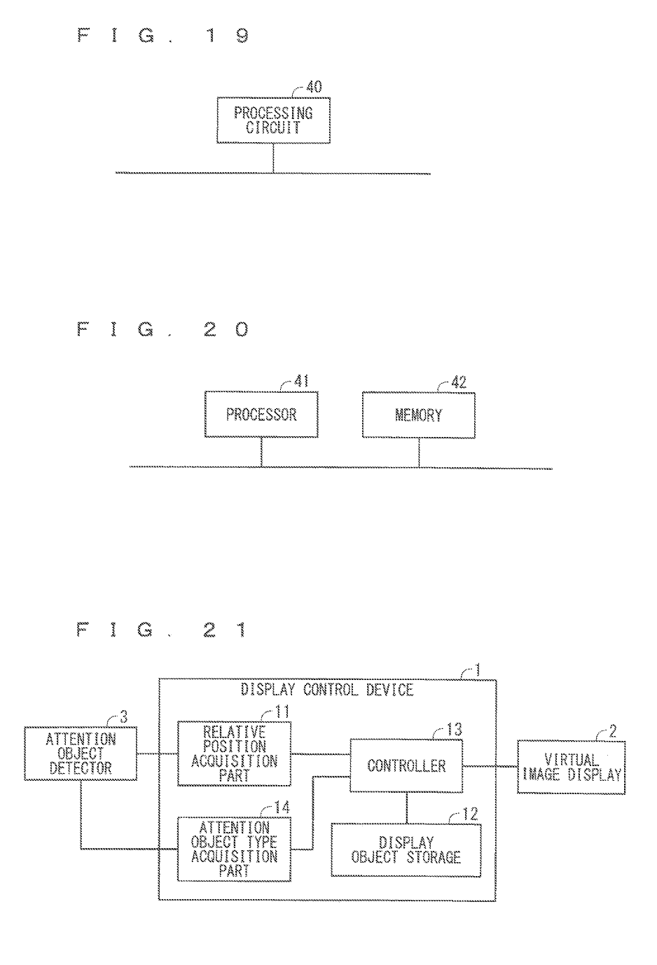

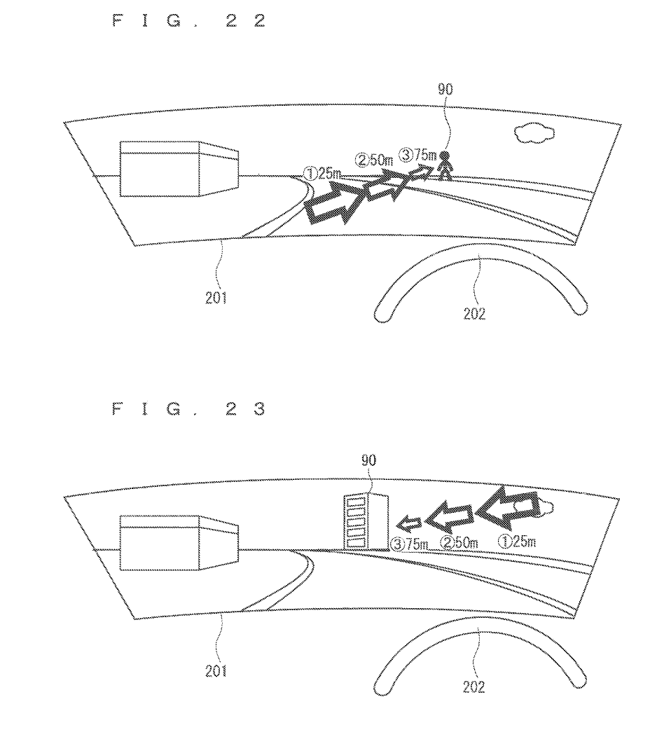

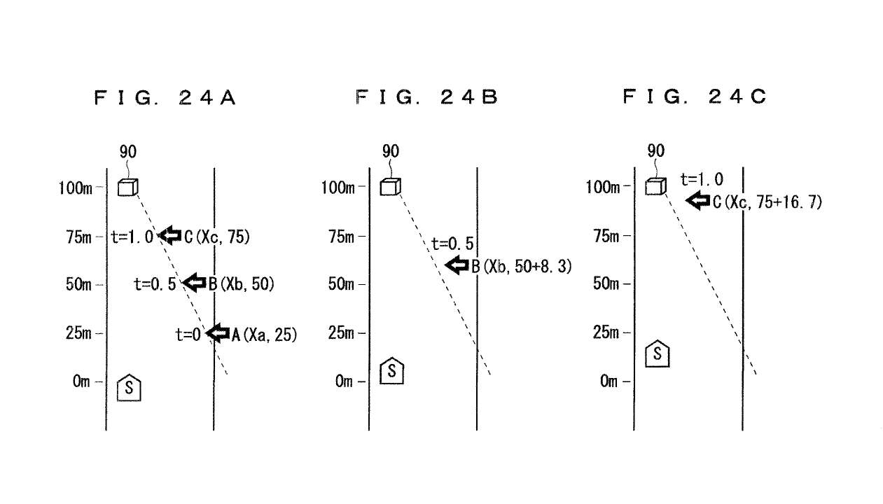

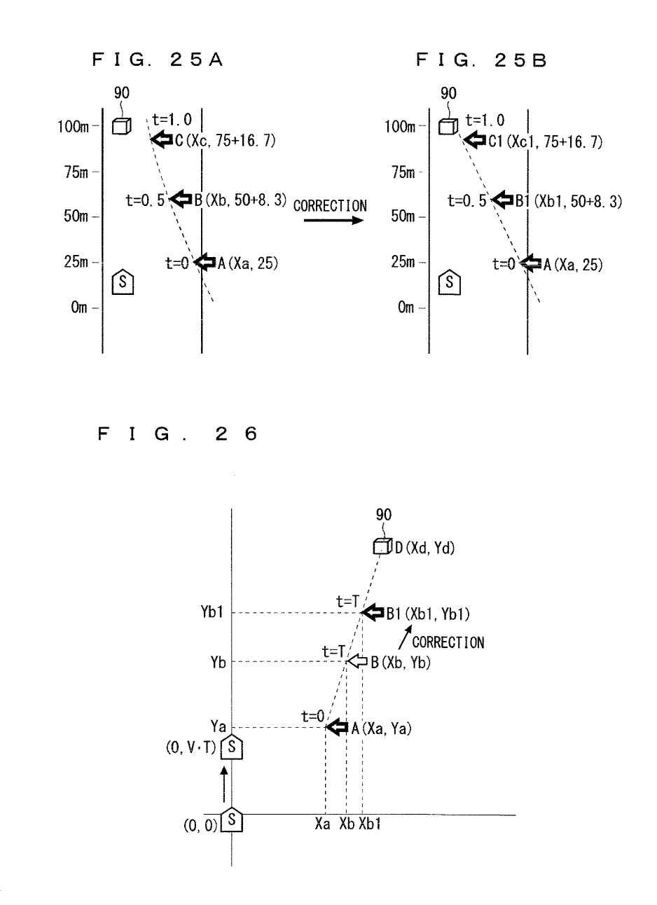

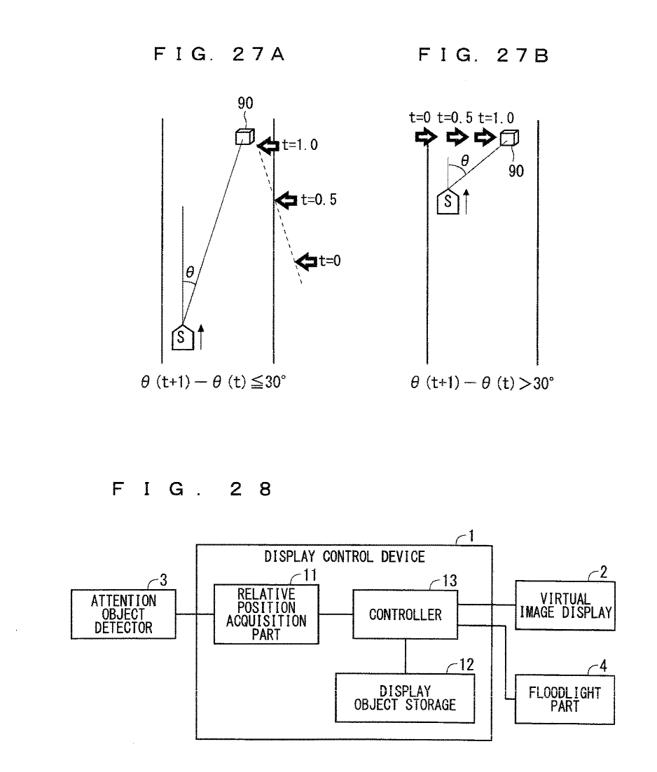

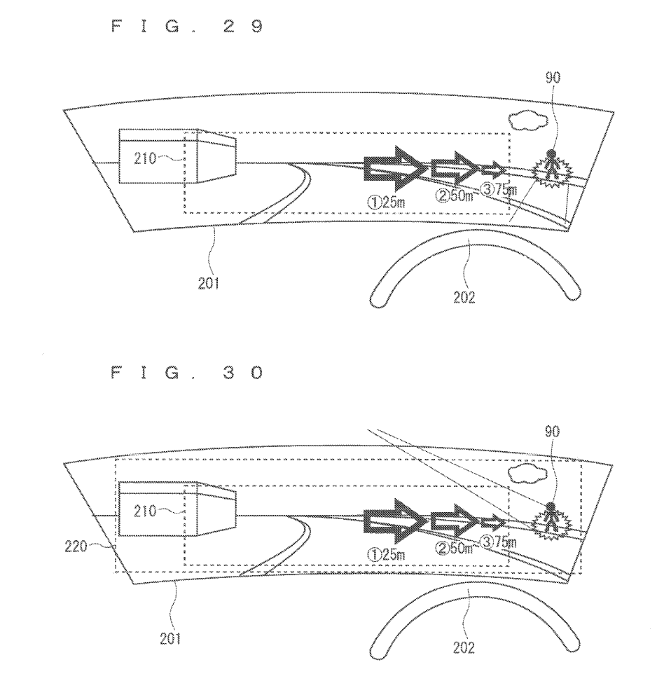

### BRIEF DESCRIPTION OF DRAWINGS

[FIG. 1] A block diagram illustrating a configuration of a display control device according to an embodiment 1.

[FIG. 2] A drawing for describing a virtual image (a display object) displayed by a virtual image display.

[FIG. 3] A drawing for describing the display object displayed by the virtual image display.

[FIG. 4] A drawing for describing the display object displayed by the virtual image display.

[FIG. 5] A drawing for describing the display object displayed by the virtual image display.

[FIG. 6] A flow chart illustrating an operation of display control device according to the embodiment b 1.

[FIG. 7] A drawing for describing an operation of the display control device according to the embodiment 1.

[FIG. 8] A drawing illustrating an example of a visual guidance object.

[FIG. 9] A drawing illustrating a display example of the visual guidance object in the present description.

[FIG. 10] A drawing illustrating an example of the visual guidance object.

[FIG. 11] A drawing illustrating an example of the visual guidance object.

[FIG. 12] A drawing illustrating an example of the visual guidance object.

[FIG. 13] A drawing illustrating an example of the visual guidance object.

[FIG. 14] A drawing illustrating an example of the visual guidance object.

[FIG. 15] A drawing illustrating an example of the visual guidance object.

[FIG. 16] A drawing illustrating an example of the visual guidance object.

[FIG. 17] A drawing illustrating an example of the visual guidance object.

[FIG. 18] A drawing illustrating an example of the visual guidance object.

[FIG. 19] A drawing illustrating an example of a hardware configuration of the display control device according to the embodiment 1.

[FIG. 20] A drawing illustrating an example of a hardware configuration of the display control device according to the embodiment 1.

[FIG. 21] A block diagram illustrating a configuration of a display control device according to an embodiment 2.

[FIG. 22] A drawing illustrating an example of the visual guidance object.

[FIG. 23] A drawing illustrating an example of the visual guidance object.

[FIG. 24] A drawing for describing a deviation of a virtual image position of the visual guidance object.

[FIG. 25] A drawing for describing a correction of a virtual image position of a visual guidance object in an embodiment 3.

[FIG. 26] A drawing for describing a correction of the virtual image position of the visual guidance object in the embodiment 3.

[FIG. 27] A drawing for describing a modification example of the embodiment 3.

[FIG. 28] A block diagram illustrating a configuration of a display control device according to an embodiment 4.

[FIG. 29] A drawing for describing an operation of a floodlight part disposed outside an own vehicle.

[FIG. 30] A drawing for describing an operation of a floodlight part disposed inside the vehicle.

### DESCRIPTION OF EMBODIMENT(S)

<Embodiment 1>

FIG. 1 is a drawing illustrating a configuration of a display control device 1 according to the embodiment 1 of the present invention. In a description of the present embodiment, the display control device 1 is mounted on a vehicle, The vehicle on which the display control device 1 is mounted is referred to as “the own vehicle”.

The display control device 1 controls a virtual image display 2 displaying an image as a virtual image in a visual field of a driver such as a HUD, for example. Connected to the display control device 1 is an attention object detector 3 for detecting an attention object (an object to which a driver of a vehicle should be alerted) such as a pedestrian or a bicycle around the own vehicle. Herein, an example of externally connecting the virtual image display 2 to the display control device 1 is described, however, the virtual image display 2 may be formed to be integral with the display control device 1. That is to say, the display control device 1 and the virtual image display 2 may be formed as one display device.

The virtual image displayed by the virtual image display 2 is described with reference to FIG. 2 and FIG. 3. In the present description, the virtual image displayed by the virtual image display 2 is referred to “the display object”. The virtual image display 2 can display the display object 100 in a position which can be visually recognized from a position of a driver 200 in the own vehicle through a windshield 201 as illustrated in FIG. 2. The position in which the display object 100 is actually displayed is located on the windshield 201, however, the display object 100 is viewed from the driver 200 as if it really existed in a landscape in front of the vehicle.

In the present description, the apparent display position of the display object 100 viewed from the driver 200 is referred to as “the virtual image position”. The virtual image position is defined by “a virtual image direction” which is a direction of the display object 100 based on the position of the driver 200 and “a virtual image distance” which is an apparent distance from the position of the driver 200 to the display object 100. As described above, a reference point for defining the virtual image position is preferably the position of the driver 200, however, a specific position in the vehicle which can be considered as the position of the driver 200 may also be applied to the reference point, so that a driver's seat or the windshield 201 may also be applied to the reference point, for example.

The virtual mage direction substantially corresponds to the position of the display object 100 on the windshield 201 viewed from the driver 200, and is expressed by a variation angle (θᵢ, φᵢ) of a three-dimensional polar coordinate system as illustrated in FIG. 3, for example. The virtual age distance substantially corresponds to an apparent distance from the driver 200 to the display object 100, and is expressed as a moving radius (rᵢ) of the three-dimensional polar coordinate system as illustrated in FIG. 3, for example. The driver 200 can visually recognize the display object 100 in the virtual image position expressed by the three-dimensional polar coordinate system (rᵢ, θᵢ, φᵢ) by adjusting a distance Fd of a focus of his/her eyes to the virtual image distance (rᵢ).

When the virtual image position is expressed by the three-dimensional polar coordinate system, a surface in which the virtual image distance (rᵢ) is equal forms into a spherical surface, however, when the virtual image direction is limited to a certain range (the front side of the vehicle) as in the case of the virtual image display 2 for the vehicle, it is also applicable to cause the surface in which the virtual image distance is equal to be approximate to a planar surface. In a description described hereinafter, the surface in which the virtual image distance is equal is treated as a planar surface as illustrated in FIG. 4 (a travel direction of the vehicle is defined as a y axis, and a planar surface of y=rᵢ is defined as a display surface of the virtual image distance rᵢ in FIG. 4).

Next, the attention object detected by the attention object detector 3 is described. Examples of the attention object include a moving body (a vehicle, a bike, a bicycle, or a pedestrian, for example), an obstacle (a falling object, a guardrail, or a level difference, for example), a specific point (an intersection and a high-accident location, for example), and a specific feature (a landmark, for example) around the own vehicle. In the attention objects described above, the moving body and obstacle around the own vehicle can be detected using a millimeter wave radar of the own vehicle, a DSRC (Dedicate Short Range Communication) unit, or a camera (an infrared camera, for example), for example. The specific point and feature can be detected based on a map information including a positional information of each point and feature and a positional information of the own vehicle.

Going back to FIG. 1 the display control device 1 includes a relative position acquisition part 11 a display object storage and a controller 13.

The relative position acquisition part 11 obtains a relative position of the attention object detected by the attention object detector 3 and the own vehicle. The relative position of the own vehicle and the moving body and obstacle around the own vehicle can be obtained from an output data of a millimeter wave radar of the own vehicle, an output data of a DSRC unit, or an analysis result of a video taken with a camera. The relative position of the specific point and feature can be calculated from the positional information of the specific point and feature included in the map information acid the positional information of the own vehicle. In the present embodiment, the attention object detector 3 calculates the relative position of the detected attention object, and the relative position acquisition part 11 obtains the calculation result. Alternatively, the relative position acquisition part 11 may calculate the relative position of the attention object from the information obtained from the attention object detector 3.

The display object storage 12 stores an image data of a plurality of display objects in advance. The display object stored in the display object storage 12 includes, for example, an image of a warning mark for informing the driver of a presence of the attention object and an image for indicating a direction of the attention object (for example, a graphic of an arrow).

The controller 13 collectively controls each constituent element of the display control device 1 and also controls the display of the virtual image displayed by the virtual image display 2. For example, the controller 13 can display the display object stored in the display object storage 12 in the visual field of the driver 200 using the virtual image display 2. The controller 13 can control the virtual image position (the virtual image direction and the virtual image distance) of the display object displayed by the virtual image display 2.

Herein, the virtual image display 2 is assumed to be able to set the virtual image distance of the display object, selecting from 25 m, 50 m, and 75 m. The controller 13 can cause the virtual image display 2 to display a first display object 101a whose virtual image distance is 25 m, a second display object 101b whose virtual image distance is 50 m, and a third display object 101c whose virtual image distance is 75 m as illustrated in FIG. 4, for example. In the above case, as illustrated in FIG. 5, the drivers sees these display objects through the windshield 201 as if the first display object 101a is located 25 m ahead, the second display object 101b is located 50 m ahead, and the third display object 101c is located 75 m ahead (an element of a sign 202 is a handle of the own vehicle).

Although FIG. 5 illustrates an example that a plurality of display objects whose virtual image distances are different from each other are simultaneously displayed, the virtual image display 2 may have a configuration that only one virtual image distance can be set for the plurality of display objects which are simultaneously displayed (all of the display distances of the display objects which are simultaneously displayed are the same) when the virtual image distance of the display object can be changed.

Next, an operation of the display control device 1 is described. FIG. 6 is a flow chart illustrating the operation. When the attention object detector 3 detects the attention object (Step S1), the relative position acquisition part 11 of the display control device 1 obtains a relative position of the detected attention object and the own vehicle (Step S2).

When the relative position acquisition part 11 obtains the relative position of the attention object, the controller 13 obtains the display object for indicating the position of the attention object (for example, the graphic of the arrow) from the display object storage 12 and causes the virtual image display 2 to display the display object, thereby guiding a visual line of the driver to the attention object (Step S3). The display object displayed in Step S3, that is to say, the display object indicating the position of the attention object to guide the visual line of the driver to the attention object is referred to as “a visual guidance object” hereinafter. The display control device 1 performs the operation of these Steps S1 to S3 repeatedly.

In Step S3, the controller 13 controls the virtual image position (the virtual image direction and the virtual image distance) of the visual guidance object based on the relative position of the attention object and the own vehicle. The virtual image position control of the visual guidance object is described hereinafter.

At the time of displaying the visual guidance object, the controller 13 changes the virtual image direction and the virtual image distance of the visual guidance object so that the visual guidance object seems to move toward the position of the attention object as viewed from the driver. For example, as illustrated in FIG. 7, when an attention object 90 is detected around an area 100 m ahead, the controller 13 firstly displays the visual guidance object 102a in the virtual image distance 25 m (t=0 second), subsequently displays the visual guidance object 102b in the virtual image distance 50 m (t=0.5 seconds), and finally displays the visual guidance object 102c in the virtual image distance 75 m (t=1.5 seconds).

When the controller 13 causes the virtual image display 2 to display the visual guidance objects 102a to 102c, the controller 13 instructs the virtual image display 2 to arrange the virtual image positions of them in a straight line toward the attention object 90. According to such a configuration, the graphic of the arrow which is the visual guidance object seems to move from a near side of the driver toward the attention object 90 (a falling object) as viewed from the driver, as illustrated in FIG. 8. This movement of the visual guidance object effectively guides the visual line of the driver toward the attention object 90. As a result, the attention of the driver to the attention object can be roused.

The movement of the visual guidance object (the graphic of the arrow) is illustrated using three drawings in FIG. 8, however, the movement is described using one drawing as part (a) of FIG. 9. Each of circled numbers and values of the distances assigned to each visual guidance object expresses an order of display of the visual guidance object and the virtual image distance. In some cases, the movement of the visual guidance object may be expressed by a two-dimensional drawing as part (b) of FIG. 9, and a hourly variation of the virtual image distance may be expressed by a drawing as part (c) of FIG. 9. Each of parts (a) to (c) of FIG. 9 illustrates the movement of the visual guidance object FIG. 8.

FIG. 8 and FIG. 9 illustrate an example that all of the images of the visual guidance objects are expressed as the same graphic of the arrow, however, the image of the visual guidance object may be changed with time (during the movement of the visual guidance object). For example, as illustrated in parts (a) and (b) of FIG. 10, the image of the visual guidance object may change from the image in a root side of the arrow to a tip side of the arrow as the visual guidance object moves toward the attention object 90. As illustrated in parts (a) and (b) of FIG. 11, a part of the image of the arrow processed to be narrow as closer to the tip of the arrow may be used as the visual guidance object. Achievable in the above case is a perspective as if the arrow were located farther as closer to its tip, thus the visual line of the driver can be guided forward more effectively. Of course, the image of the visual guidance object is not limited to the arrow, but an optional image may also be applicable. For example, FIG. 12 illustrates an example that an image of a finger of a human is applied to the visual guidance object.

The above display example describes an example that the visual guidance object moves horizontally from right to left, however, its moving direction is not limited as long as the visual guidance object seems to move toward the attention object 90. That is to say, a display-starting position of the visual guidance object (a starting point of movement of the visual guidance object) may be optionally set. For example, it is also applicable that the display-starting position of the visual guidance object is located on the left side of the attention object 90 and the visual guidance object moves from left to right.

When the display-starting position of the visual guidance object is located on an upper side (or a lower side) of the attention object 90 as illustrated in FIG. 13, an angle can be added to an apparent moving direction (a moving direction of the virtual image position) of the visual guidance object. At this time, the angle of the moving direction of the visual guidance object (the angle with the horizontal direction) may be changed in accordance with a distance from the own vehicle to the attention object 90. Considered, for example, is a configuration that the angle of the moving direction of the visual guidance object increases in a case where the attention object 90 is located close to the own vehicle as illustrated in FIG. 14 compared with a case where the attention object 90 is located farther from the own vehicle as illustrated in FIG. 13 (the display-starting position is brought close to the position right above the attention object 90). A degree of urgency of the attention object 90 can be expressed by the angle of the moving direction of the visual guidance object.

The moving direction of the visual guidance object needs not have a linear pattern, but the visual guidance object may be moved in a curved pattern as illustrated in FIG. 15, for example. Accordingly, a region where the virtual image display 2 can be displayed (a displayable region of the display object) can be effectively used.

When a displayable region 210 of the display object is narrower than the windshield 201 as illustrated in FIG. 16, the attention object 90 viewed outside the displayable region 210 from the driver (the pedestrian herein) may be detected by the attention object detector 3 in some cases. In the above case, a starting point and an ending point of the movement of the visual guidance object need to be determined so that the attention object 90 is located on an extension of a trajectory along which the visual guidance object moves and a final position of the visual guidance object (the ending point of the movement of the visual guidance object) is located as close to the attention object 90 as possible (an end part of the displayable region 210). Accordingly, the visual line of the driver can also be guided to the attention object 90 located outside the displayable region 210.

The above display example describes the example that the virtual image distance changes as the visual guidance object moves, however, in doing so, the visual guidance object can only move in the three-step manner when only the three types of the virtual image distance can be set as the present embodiment, so that a variation of the movement of the visual guidance object is limited. Thus, in such a case, it is also applicable to include a step of moving the visual guidance object without changing the virtual image distance during the movement of the virtual guidance object as illustrated in part (a) and (b) of in FIG. 17, for example.

When the virtual image display 2 can change the virtual image distance in multi-steps of four or more steps or in a continuous manner, the visual guidance object can be moved more smoothly as illustrated in part (a) and (b) of in FIG. 18, thus a visibility of the visual guidance object is enhanced.

It is also applicable to combine a continuous change of the virtual image distance and a non-continuous (step-by-step) change of the virtual image distance. For example, it is applicable that the virtual image distance of the visual guidance object is continuously changed in a range of virtual image distance 0 m to 50 m, and the virtual image distance of the visual guidance object is non-continuously changed such as 55 m, 60 m, 70 m, and 75 m in a range of virtual image distance 50 m to 75 m, for example.

Since a recognition accuracy of a difference and change in the distance is reduced with distance in human eyes, it is also applicable to increase a change rate of the virtual image distance as the virtual image distance of the visual guidance object increases. When the virtual image distance of the visual guidance object is non-continuously changed, it is also applicable to increase the change rate of the virtual image distance as the virtual image distance increases, for the similar reason. For example, it is also applicable that the virtual image distance of the visual guidance object changes with increments of 1 m in a range of virtual image distance 25 m to 30 m, the virtual image distance of the visual guidance object changes with increments of 2 m in a range of virtual image distance 30 m to 50 m, and the virtual image distance of the visual guidance object changes with increments of 5 m in a range of virtual image distance 50 m to 75 m.

A pattern of changing the virtual image distance of the visual guidance object is not limited to the example described above, but the virtual image distance may be changed in a linear pattern or a non-linear pattern, for example. A logarithmic change is preferable in view of a human sense. Also in a case where the virtual image distance is continuously changed or non-continuously changed, the change rate of the virtual image distance may be constant or also may be increased as the virtual image distance increases.

FIG. 19 and FIG. 20 are drawings each illustrating an example of a hardware configuration of the display control device 1. The relative position acquisition part 11 and the controller 13 in the display control device 1 are achieved by a processing circuit 40 illustrated in FIG. 19, for example. That is to say, the processing circuit 40 includes the relative position acquisition part 11 for obtaining the relative position of the attention object and the own vehicle and the controller 13 for changing, at the time of displaying the visual guidance object, the virtual image direction and the virtual image distance of the visual guidance object in accordance with time so that the visual guidance object seems to move toward the position of the attention object as viewed from the driver, based on the relative position of the own vehicle and the attention object. A dedicated hardware may be applied to the processing circuit 40, or a processor for executing a program stored in a memory (a Central Processing Unit, a processing apparatus, an arithmetic device, a microprocessor, a microcomputer, a Digital Signal Processor) may also be applied to the processing circuit 40.

When the processing circuit 40 is the dedicated hardware, a single circuit, a complex circuit, a programmed processor, a parallel-programmed processor, an ASIC, a FPGA, or a combination of them, for example, falls under the processing circuit 40. Each function of the relative position acquisition part 11 and the controller 13 may be achieved by the plurality of processing circuit 40, or each function of them may also be collectively achieved by one processing circuit 40.

FIG. 20 illustrates a hardware configuration of the display control device 1 in case Where the processing circuit 40 is the processor. In the above case, the functions of the relative position acquisition part 11 and the controller 13 are achieved by a combination with a software (a software, a firmware, or a software and a firmware), for example. The software, for example, is described as a program and is stored in a memory 42. A processor 41 as the processing circuit 40 reads out and executes a program stored in the memory 42, thereby achieving the function of each part. That is to say, the display control apparatus 1 includes the memory 42 to store the program to resultingly execute, at a time of being executed by the processing circuit 40, a step of obtaining the relative position of the attention object and the own vehicle and a step of changing, at the time of displaying the visual image object, the virtual image direction and the virtual image distance of the visual guidance object in accordance with time so that the visual guidance object seems to move toward the position of the attention object as viewed from the driver, based on the relative position of the own vehicle and the attention object. In other words, this program is also deemed to cause a computer to execute a procedure or a method of the relative position acquisition part 11 and the controller 13. Herein, a non-volatile or volatile semiconductor memory such as a RAM (Random Access Memory), a ROM (Read Only Memory), a flash memory, an EPROM (Erasable Programmable Read Only Memory), or an EEPROM (Electrically Erasable Programmable Read Only Memory), an HDD (Hard Disk Drive), a magnetic disc, a flexible disc, an optical disc, a compact disc, a mini disc, a DVD (Digital Versatile Disc), or a drive device of them, for example, falls under the memory 42.

Described above is the configuration that each function of the relative position acquisition part 11 and the controller 13 is achieved by one of the hardware and the software, for example. However, the configuration is not limited thereto, but also applicable is a configuration of achieving a part of the relative position acquisition part 11 and the controller 13 by a dedicated hardware and achieving another part of them by a software, for example. For example, the function of the controller 13 can be achieved by a processing circuit as the dedicated hardware, and the function of another part can be achieved by the processing circuit 40 as the processor 41 reading out and executing the program stored in the memory 42.

As described above, the processing circuit 40 can achieve each function described above by the hardware, the software, or the combination of them, for example. Although the display object storages 12 are made up of the memory 42, they may be made up of one memory 42 or each of them may also be made up of the individual memory 42.

The display control device described above can be applied to a Portable Navigation Device which can be mounted on the vehicle, a communication terminal (a portable terminal such as a mobile phone, a smartphone, or a tablet, for example), a function of an application installed on them, and a display control system constructed as a system by appropriately combining a server, for example. In the above case, each function or each constituent element of the display control device described above may be dispersedly disposed in each apparatus constructing the system described above, or may also be collectively disposed in one of the apparatuses.

<Embodiment 2>

FIG. 21 is a block diagram illustrating a configuration of the display control device 1 according to the embodiment 2. The display control device 1 has a configuration that an attention object type acquisition part 14 for obtaining a type f the attention object detected by the attention object detector 3 (for example, an identification information such as the vehicle, the pedestrian, or the landmark, for example) is added to the configuration of FIG. 1.

In the embodiment 2, the attention object detector 3 determines the type of the detected attention object from the output data of the millimeter wave radar of the own vehicle, the output data of the DSRC unit, the analysis result of the video taken the camera, or the map information, and the attention object type acquisition part 14 obtains the determination result. Alternatively, the attention object type acquisition part 14 may determine the type of the attention object from the information obtained from the attention object detector 3.

The display control device 1 according to the embodiment 2 is also achieved by the hardware configuration illustrated in FIG. 19 or FIG. 20. That is to say, the attention object type acquisition part 14 is also achieved by the processing circuit 40 or the processor 41 executing the program.

In the embodiment 2, when the controller 13 displays the visual guidance object indicating the position of the attention object, the controller 13 changes the display-starting position of the visual guidance object (the position where the visual guidance object is displayed for the first time) in accordance with the type of the attention object.

For example, when the attention object 90 is the pedestrian as illustrated in FIG. 22, the display-starting position of the visual guidance object is provided on a road in front of the own vehicle so that the driver can recognize the attention object 90 more easily. When the attention object 90 is the building (landmark) as illustrated in FIG. 23, the display-starting position of the visual guidance object is provided outside the road in front of the own vehicle so that the visual guidance object does not get in the way of the driving.

According to the present embodiment, a degree of rousing attention to the driver can be adjusted in accordance with the importance of the attention object 90. The above configuration enables an achievement of an effect that the attention of the driver is relatively roused more strongly with increase in importance of the attention object 90.

<Embodiment 3>

In the embodiment 1, a positional change of the own vehicle is ignored when the virtual image position of the visual guidance object is moved. No problem arises in the above case when the own vehicle moves at a low speed or a travel time of the visual guidance object is short. However, when the own vehicle moves at a high speed or the travel time of the visual guidance object is long, the relative position of the own vehicle and the attention object is significantly changed during moving the visual guidance object, thus the virtual image position of the visual guidance object needs to be determined in view of the positional change of the own vehicle so that the visual guidance object seems to move toward the attention object.

FIG. 24 is a drawing for describing a deviation of the virtual image position of the visual guidance object due to the positional change of the own vehicle. The deviation is described herein using a two-dimensional planar surface ignoring a positional relationship in a height direction for simplification. When the position of the own vehicle S is not changed, the virtual image position of the visual guidance object needs to be changed and linearly moved in order of A, B, and C at 0:5 second interval, for example, as shown in part (a) of FIG. 24 so that the visual guidance object (the graphic of the arrow) seems to move toward the attention object 90.

However, when the own vehicle S moves at 60 km per hour, for example, the position of the own vehicle moves forward a distance of 8.3 m after 0.5 seconds of displaying the visual guidance object in the virtual position A, thus as illustrated in part (b) of FIG. 24, the virtual image position B of the visual guidance object is deviated by 8.3 m in the travel direction (the Y direction) of the own vehicle S. The virtual image position C of the visual guidance object displayed 0.5 seconds after then is deviated by 16.7 m in the travel direction of the own vehicle S as illustrated in part (c) of FIG. 24.

That is to say, even when the display control device 1 linearly moves the virtual image position of the visual guidance object based on the own vehicle S, the visual guidance objects seems to move toward a direction different from the attention object 90, as illustrated in part (a) of FIG. 25, in a case where the own vehicle S moves. Thus, in the present embodiment, the virtual image position of the visual guidance object is corrected so that the virtual image position of the visual guidance object seems to move toward the attention object 90 as illustrated in part (b) of FIG. 25 even when the position of the own vehicle S changes.

FIG. 26 is a drawing for describing the correction of the virtual image position of the visual guidance object in the embodiment 3. Described hereinafter is an example of correcting the position of the virtual image position of the visual guidance object in a horizontal direction (X direction).

Herein, t=0 indicates a time when the display control device 1 which has detected the attention object 90 displays the visual guidance object, which indicates the position of the attention object 90, for the first time, and an X-Y plane in which the position of the own vehicle S in t=0 is defined as an original point (the travel direction of the own vehicle is defined as the Y axis). A point D (Xd, Yd) indicates the position of the attention object 90. A point A (Xa, Ya) indicates the position where the visual guidance object is displayed for the first time (the display-starting position). Moreover, a point B (Xb, Yb) indicates the position where the visual guidance object is displayed subsequent to the point A in a case where the positional change of the own vehicle S is not considered (t=T indicates a time when the visual guidance object is displayed it the point B). A point B1 (Xb1, Yb1) indicates the position after the position of the point B is corrected in view of the positional change of the own vehicle S.

At the time t=0, the point B is located on a straight line connecting the point. A and the point D. However, when the own vehicle S moves forward, the point B is deviated in the Y direction, thereby being deviated from the straight line connecting the point A and the point D. The correction of the point B indicates a processing of converting the point B deviated from the straight line connecting the point A and the point D due to the positional change of the own vehicle S into the point B1 located on the straight line.

Firstly, an inclination α of the straight line connecting the point A and the point D is expressed as α=(Yd−Ya)/(Xd−Xa). When a speed V of the own vehicle S is constant, the position of a vehicle position S at a trine T is expressed as a coordinate (0, V·T).

A Y coordinate of the point B is changed with the position of the own vehicle S, thus the Y coordinate of the point B1 after the correction is defined as:

Yb1=Tb+V·T (1).

In the above case, an X coordinate of the point B1 is calculated as follows so that the point B1 is located on the straight line connecting the point A and the point D:

$$\begin{matrix}Xb 1 = Xa + ( Yb 1 - Yb ) / α \\ = Xa + V \cdot T / α \\ = Xa + V \cdot T \cdot ( Xd - Xa ) / ( Yd - Ya ) .\end{matrix} \qquad equation ( 2 )$$

When the display control device 1 displays the visual guidance object in the corrected point B1 defined as the above equation (1) and the equation (2) instead of displaying the visual guidance object in the point B at the time t=T, the visual guidance object seems to move from the point A toward the attention object 90 as viewed from the moving own vehicle S.

As described above, according to the present embodiment, the virtual image position of the visual guidance object is corrected in view of the positional change of the own vehicle, thus the deviation of the moving direction of the visual guidance object from the direction toward the attention object is avoided even when the own vehicle is moving. Thus, the visual line of the driver can be guided to the attention object more reliably.

However, in a case where there is a small distance from the own vehicle to the attention object, for example, the direction of the attention object viewed from the own vehicle is significantly changed when the position of the own vehicle is changed. Thus, a correction amount is considerably increased when such a correction described above is performed, and it may be difficult to recognize what the visual guidance object indicates.

Thus, it is also applicable to display the visual guidance object having a constant virtual image distance without performing the positional correction when the change rate of the direction (the angle) of the attention object viewed from the own vehicle with respect to the change rate of the position of the own vehicle exceeds a predetermined value.

For example, it is applicable when the change rate of the direction of the attention object 90 viewed from the own vehicle is estimated to be 30 degrees or smaller per one second as illustrated in part (a) of FIG. 27, the virtual image position of the visual guidance object is corrected as described above, and when the change rate of the direction of the attention object 90 viewed from the own vehicle exceeds 30 degrees per one second as illustrated in part (b) of FIG. 27, the visual guidance object having the constant virtual image distance is displayed without performing the correction described above.

In the case of the example of part (b) of FIG. 27, the virtual image distance of the visual guidance object does not change in accordance with the relative position of the attention object 90, so that the moving direction of the visual guidance object cannot indicate an accurate position of the attention object 90, but can indicate a brief direction easily viewed from the driver. The image of the visual guidance object (for example, a color or a shape) may be changed depending on the case where the correction is performed and the case where the correction is not performed.

<Embodiment 4>

FIG. 28 is a block diagram illustrating a configuration of the display control device 1 according to the embodiment 4. The display control device 1 has a configuration of adding a floodlight part 4, which can indicate the position of the attention object 90 with light, to the configuration of FIG. 1.

When the attention object 90 viewed outside the displayable region 210 from the driver is detected as the example illustrated in FIG. 16, the display control device 1 of the embodiment 4 shows the position of the attention object 90 not only with the visual guidance object displayed by the virtual image display 2 but also with the light emitted from the floodlight part 4.

Considered are the floodlight parts 4 disposed outside the own vehicle and disposed inside the vehicle. The floodlight part 4 disposed outside the own vehicle directly irradiates the attention object 90 with the light as illustrated in FIG. 29. The floodlight part 4 disposed inside the own vehicle irradiates the position on the windshield 201 where the attention object 90 is viewed from the driver with the light as illustrated in FIG. 30. As illustrated in FIG. 30, a region 220 where the floodlight part 4 can irradiate with the light on the windshield 201 is larger than the displayable region 210 of the visual guidance object.

According to the present embodiment, when the attention object 90 is detected outside the displayable region 210, the light emitted from the floodlight part 4 supplementarily shows driver the position of the attention object 90. Thus, the visual line of the driver can be guided to the attention object more reliably.

According to the present invention, the above embodiments can be arbitrarily combined, or each embodiment can be appropriately varied or omitted within the scope of the invention.

The present invention has been shown and described in detail, the foregoing description is in all aspects illustrative and not restrictive. It is therefore understood that numerous modifications and variations can be devised without departing from the scope of the invention.

### Explanation of Reference Signs

1 display control device, 2 virtual image display, 3 attention object detector, 4 floodlight part, 11 relative position acquisition part, 12 display object storage, 13 controller, 14 attention object type acquisition part, 40 processing circuit, 41 processor, 42 memory, 90 attention object, 200 driver, 201 windshield, 210 displayable region of virtual image display, 220 region where floodlight part can irradiate

1. A display control device for controlling a virtual image display, wherein
said virtual image display can display a display object being a virtual image which can be visually recognized from a driver's seat of a vehicle through a windshield of said vehicle in a virtual image position defined by a virtual image direction which is a direction of said virtual image on a basis of a specific position of said vehicle and a virtual image distance which is a distance to said virtual image on a basis of said specific position, and
said display control device comprises:
a processor to execute a program; and
a memory to store said program which, when executed by said processor, performs processes of:
obtaining a relative position of an attention object to which a driver of said vehicle should be alerted and said vehicle; and
controlling a display of said virtual image display, and
when said processor displays a visual guidance object which is a display object to guide a visual line of said driver to said attention object, said processor changes a virtual image position of said visual guidance object, based on said relative position of said vehicle and said attention object, so that said visual guidance object seems to move toward a position of said attention object as viewed from said driver.

2. The display control device according to claim 1, wherein
said processor changes an image of said visual guidance object while changing a virtual image position of said visual guidance object.

3. The display control device according to claim 2, wherein
said processor changes an image of said visual guidance object from an image in a root side of an arrow to a tip side of said arrow.

4. The display control device according to claim 1, wherein said processor changes an angle of a moving direction of said visual guidance object viewed from said driver with a horizontal direction in accordance with a distance from said vehicle to said attention object.

5. The display control device according to claim 4, wherein
said processor increases an angle of a moving direction of said visual guidance object viewed from said driver with a horizontal direction with decrease in a distance from said vehicle to said attention object.

6. The display control device according to claim 1, wherein
said processor changes a starting point of a movement of said visual guidance object in accordance with a type of said attention object.

7. The display control device according to claim 1, wherein
when said attention object is located outside a displayable region of a display object, said processor determines a starting point and an ending point of a movement of said visual guidance object so that said attention object is located on an extension of a trajectory along which said visual guidance object moves and an ending point of said movement of said visual guidance object is located in an end part of said displayable region, being a side closer to said attention object.

8. The display control device according to claim 1, wherein
said image of said visual guidance object is an image drawn to obtain a perspective in one image.

9. The display control device according to claim 1, wherein
said processor corrects said virtual image position of said visual guidance object so that a deviation of a moving direction of said visual guidance object due to a positional change of said vehicle is reduced when said vehicle is moving.

10. The display control device according to claim 9, wherein
said processor does not correct said virtual image position when a change rate of a direction of said attention object viewed from said vehicle with respect to a change rate of a position of said vehicle exceeds a predetermined value.

11. The display control device according to claim 1, wherein
said processor further controls a floodlight part which irradiates an outside of said vehicle with light, and
when said attention object is located outside a displayable region of a display object as viewed from said driver, said processor irradiates said attention object with light using said floodlight part.

12. The display control device according to claim 1, wherein
said processor further controls a floodlight part which irradiates said windshield with light, and
when said attention object is located outside a displayable region of a display object as viewed from said driver, said processor irradiates a position on said windshield where said attention object is viewed from said driver with light using said floodlight part.

13. A display device, comprising:
said display control device according to claim 1; and
said virtual image display.

14. A display control method of controlling a virtual image display, wherein
said virtual image display can display a display object being a virtual image which can be visually recognized from a driver's seat of a vehicle through a windshield of said vehicle in a virtual image position defined by a virtual image direction which is a direction of said virtual image on a basis of a specific position of said vehicle and a virtual image distance which is a distance to said virtual image on a basis of said specific position, and
said display control method comprises:
obtaining a relative position of an attention object to which a driver of said vehicle should be alerted and said vehicle; and
when a visual guidance object which is a display object to guide a visual line of said driver to said attention object is displayed, changing a virtual image position of said visual guidance object, based on said relative position of said vehicle and said attention object, so that said visual guidance object seems to move toward a position of said attention object as viewed from said driver.
